(19) United States
(12) Patent Application Publication
(10) Pub. No.: US 2026/0019298 A1
(43) Pub. Date: Jan. 15, 2026

(54) METHOD OF DETECTING INTRUSION IN VEHICLE NETWORK AND APPARATUS FOR PERFORMING THE SAME

(71) Applicant: 42dot Inc., Gyeonggi-do (KR)

(72) Inventor: Sungyong Lee, Gyeonggi-do (KR)

(73) Assignee: 42dot Inc., Gyeonggi-do (KR)

(21) Appl. No.: 19/266,670

(22) Filed: Jul. 11, 2025

(30) Foreign Application Priority Data
Jul. 12, 2024 (KR) 10-2024-0092266

(51) Int. Cl. H04L 12/40; H04L 67/12

(52) U.S. Cl. CPC H04L 12/40104; H04L 67/12; H04L 2012/40215; H04L 2012/40273

(57) ABSTRACT

A method of detecting intrusion in a vehicle network using a plurality of modules is disclosed. The method according to an embodiment includes sequentially acquiring, by a first module that performs decoding among the plurality of modules, a message transmitted within the vehicle network, transmitting, by the first module, the message to a second module that detects intrusion among the plurality of modules, by sequentially decoding the message, and sequentially detecting intrusion with respect to a message output from the first module by the second module. The plurality of modules may each include a message queue, and may perform an operation in parallel based on the message queue.

### CROSS-REFERENCE TO RELATED APPLICATION

This application claims the benefit of Korean Patent Application No. 10-2024-0092266 filed on Jul. 12, 2024, in the Korean Intellectual Property Office, the entire disclosure of which is incorporated herein by reference for all purposes.

### BACKGROUND

### 1. Field of the Invention

The disclosure relates to a method of detecting intrusion in a vehicle network and an apparatus for performing the same.

### 2. Description of the Related Art

As a type of security software, an intrusion detection and prevention system (IDPS) may be a combination of an intrusion detection system (IDS) and an intrusion prevention system (IPS), and may be implemented in an apparatus and/or software to detect and respond to intrusions or malicious acts from the outside. As the number of electronic control units (ECUs) mounted on vehicles increases significantly and vehicles are connected to external networks, IDS and/or IDPS are being introduced to detect and respond to security threats to the internal network of vehicles.

A related art is Korean Patent Publication No. 10-2642875 (Title of the invention: System and method for providing security to in-vehicle network).

The above description has been possessed or acquired by the inventor(s) in the course of conceiving the present disclosure and is not necessarily an art publicly known before the present application is filed.

### SUMMARY

An embodiment may provide a technique for efficiently detecting intrusions using modules that perform tasks in parallel.

An embodiment may provide a technique for quickly performing tasks for a next message using a message queue.

However, the technical aspects are not limited to the aforementioned aspects, and other technical aspects may be present.

According to an aspect, there is provided a method of detecting intrusion in a vehicle network using a plurality of modules including sequentially acquiring, by a first module that performs decoding among the plurality of modules, a message transmitted within the vehicle network, transmitting, by the first module, the message to a second module that detects intrusion among the plurality of modules, by sequentially decoding the message, and sequentially detecting intrusion with respect to a message output from the first module by the second module.

The plurality of modules may each include a message queue, and may perform operations in parallel based on the message queue.

The second module may include a plurality of detection engines, and each of the plurality of detection engines may sequentially detect intrusion with respect to the message output from the first module, based on a corresponding detection scheme.

The method may further include when at least one detection engine of the plurality of detection engines detects intrusion with respect to the decoded message, transmitting a detection result to a third module that processes detection results among the plurality of modules by the detection engine that detects the intrusion.

The method may further include transmitting the message output from the first module to a next detection engine by the detection engine that detects the intrusion.

The plurality of modules may be connected in a plug-in form.

The vehicle network may include a controller area network (CAN) for communication between components in a vehicle.

According to another aspect, there is provided an apparatus for detecting intrusion in a vehicle network using a plurality of modules including at least one processor and memory including instructions. The instructions, when executed individually or collectively by the at least one processor, may cause the apparatus to sequentially acquire, by a first module that performs decoding among the plurality of modules, a message transmitted within the vehicle network, transmit, by the first module, the message to a second module that detects intrusion among the plurality of modules, by sequentially decoding the message, and sequentially detect intrusion with respect to a message output from the first module by the second module.

The plurality of modules may each include a message queue, and may perform operations in parallel based on the message queue.

The second module may include a plurality of detection engines, and each of the plurality of detection engines may sequentially detect intrusion with respect to the message output from the first module, based on a corresponding detection scheme.

The instructions, when executed individually or collectively by the at least one processor, may cause the apparatus to when at least one detection engine of the plurality of detection engines detects intrusion with respect to the decoded message, transmit a detection result to a third module that processes detection results among the plurality of modules by the detection engine that detects the intrusion.

The instructions, when executed individually or collectively by the at least one processor, may cause the apparatus to transmit the message output from the first module to a next detection engine by the detection engine that detects the intrusion.

The plurality of modules may be connected in a plug-in form.

The vehicle network may include a CAN for communication between components in a vehicle.

Additional aspects of embodiments will be set forth in part in the description which follows and, in part, will be apparent from the description, or may be learned by practice of the disclosure.

### BRIEF DESCRIPTION OF THE DRAWINGS

With regard to the description of the drawings, like or similar reference numerals may be used to refer to like or similar elements.

FIG. 1 is a diagram illustrating a communication environment of a vehicle, according to an embodiment.

FIG. 2 is a diagram illustrating an apparatus that detects intrusion in a vehicle network, according to an embodiment.

FIG. 3 is a diagram illustrating an intrusion detection device in a vehicle network, according to an embodiment.

FIG. 4 is a flowchart illustrating a system initialization process according to an embodiment.

FIG. 5 is a flowchart illustrating an intrusion detection process according to an embodiment.

FIG. 6 is a flowchart illustrating a method of detecting intrusion in a vehicle network according to an embodiment.

FIG. 7 is a schematic block diagram of an electronic device according to an embodiment.

### DETAILED DESCRIPTION

The following structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an ASIC, and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like components, and any repeated description related thereto will be omitted.

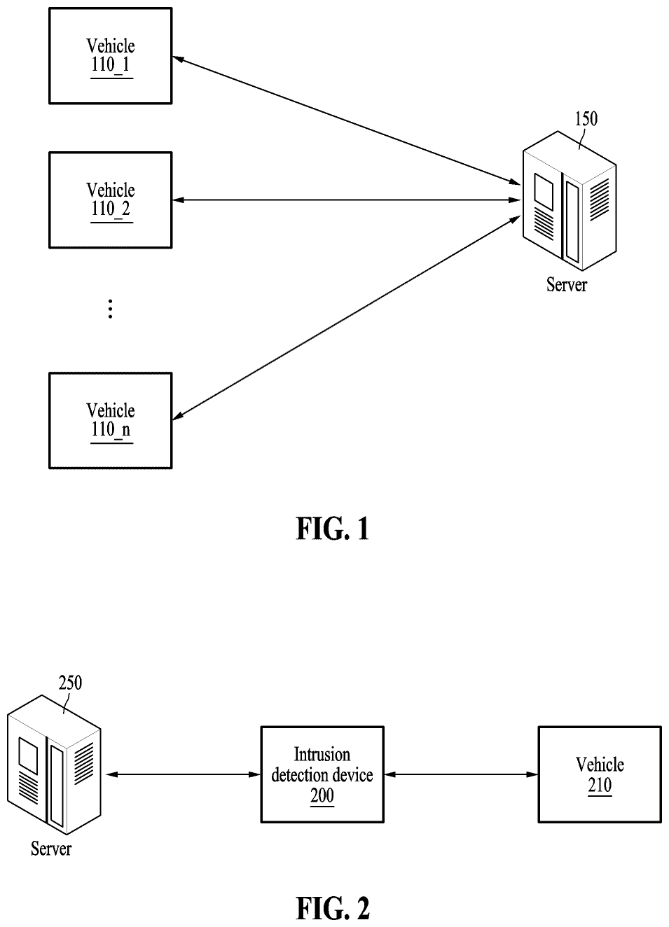

FIG. 1 is a diagram illustrating a communication environment of a vehicle, according to an embodiment.

Referring to FIG. 1, according to an embodiment, vehicles 110_1 to 110_n may include an internal communication system for communication between components (e.g., electronic control units (ECUs)) within the vehicles 110_1 to 110_n and an external communication system for communication with the outside. The components within the vehicles 110_1 to 110_n may perform communication using a vehicle network. The vehicle network may include networks such as a controller area network (CAN), a local interconnect network (LIN), a media oriented systems transport (MOST), and ethernet. CAN may be a network protocol developed for real-time data communication between components within the vehicles 110_1 to 110_n. For example, components such as an engine control unit, a transmission control unit, and an airbag control unit may communicate via a CAN BUS. The vehicles 110_1 to 110_n may communicate with an external server (e.g., a server 150). The vehicles 110_1 to 110_n may communicate with the server 150 to transmit and/or receive information. For example, the vehicles 110_1 to 110_n may transmit data related to the vehicles 110_1 to 110_n (e.g., data related to the vehicles such as driving data, charging data, and engine state) to the server 150, and the server 150 may analyze the data to provide services such as state monitoring, remote diagnosis, and file updates for the vehicles 110_1 to 110_n. The vehicles 110_1˜110_n may be vehicles for transporting people and/or cargo, and may include vehicles such as, for example, automobiles, trains, shipping, boats, aircraft, kickboards and/or bicycles. The vehicles 110_1 to 110_n may communicate with the server 150 using a network (not shown). For example, the network may include a local area network (LAN), a wide area network (WAN), a value added network (VAN), a mobile radio communication network, a satellite communication network, and a combination thereof. The network may be a comprehensive data communication network that allows the vehicles 110_1 to 110_n and the server 150 to communicate smoothly with each other, and may include wired Internet, wireless Internet, and a mobile wireless communication network. In addition, the wireless communication network may include for example, but is not limited to, a wireless LAN (Wi-Fi), Bluetooth, Bluetooth low energy, Zigbee, Wi-Fi direct (WFD), ultra-wideband (UWB), infrared data association (IrDA), near field communication (NFC), and the like.

FIG. 2 is a diagram illustrating an apparatus that detects intrusion in a vehicle network, according to an embodiment.

Referring to FIG. 2, according to an embodiment, an intrusion detection device 200 (e.g., an electronic device 700 of FIG. 7) may detect a security threat (e.g., an intrusion or an attack) to a network inside a vehicle 210 (e.g., the vehicles 110_1 to 110_n of FIG. 1). A security threat may be a violation of security attributes (e.g., confidentiality, availability, and the like) that a system (e.g., a vehicle system) should have. A vehicle system may include systems such as electronic control systems and infotainment systems of the vehicle 210. The security threat may include attacks such as a flooding attack, replay attack, denial of service (DoS) attack, land attack, address resolution protocol (ARP) spoofing, smurf attack, and ping of death (PoD) attack. The flooding attack may be an attack that causes excessive traffic to a network (e.g., a vehicle network) to exhaust network resources, which may hinder the availability of the network. The replay attack may be an attack that deceives a user by retransmitting a previously transmitted valid message to appear authenticated, which may violate the reliability of the system. The DoS attack may be an attack that interferes with a normal operation of a system, preventing a user from using a service, which may hinder the availability of the system. The land attack may be an attack that sends packets to a system by setting source and destination IP addresses to be the same, which may hinder the availability of the system. The ARP spoofing may be an attack in which an attacker steals or modifies packets by disguising their own media access control (MAC) address as a destination IP address, which may violate the confidentiality and reliability of the system. The smurf attack may be an attack in which a large number of internet control message protocol (ICMP) packets are broadcast while setting a source IP address to a system to be attacked. The smurf attack may be an attack in which a large number of responses are flooded into the system, paralyzing network traffic and hindering the availability of the system. The POD attack may be an attack in which an abnormally large ICMP packet is transmitted to a system to crash or stop the system, which may hinder the availability of the system. The intrusion detection device 200 may detect and prevent security threats including intrusions and/or attacks on the vehicle 210. The intrusion detection device 200 may be installed inside the vehicle 210 or outside (e.g., a server 250) the vehicle 210 to detect intrusion into a network (e.g., a vehicle network) inside the vehicle 210.

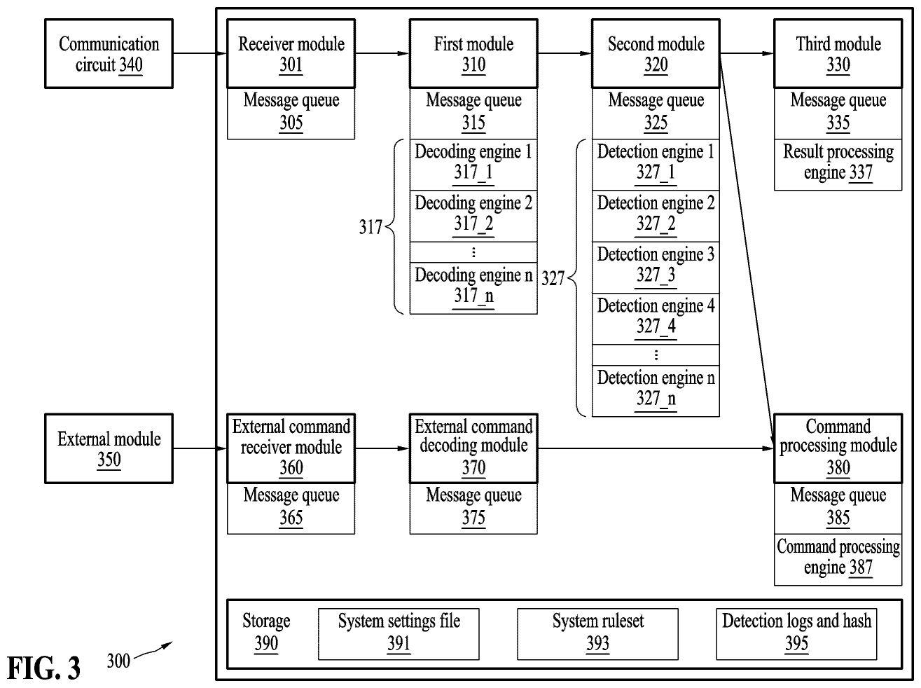

According to an embodiment, the intrusion detection device 200 may detect intrusion in a vehicle network using a plurality of modules. The plurality of modules may be independent code blocks that perform a given task and may be executed on a processor (e.g., the processor 730) of the intrusion detection device 200. Each module may process data or interact with other modules. The plurality of modules may include a receiver module (e.g., a receiver module 301 of FIG. 3), a first module (e.g., a first module 310) that performs decoding, a second module (e.g., second module 320) that detects intrusion, and a third module (e.g., a third module 330) that processes a detection result. The plurality of modules may be connected in a plug-in form. A plug-in form structure may be a structure that is modularized and connected such that new functions may be easily added or deleted to a software system. Since the plurality of modules are connected in a plug-in form, new modules may be easily inserted between specific modules, or existing modules may be easily deleted. The plurality of modules of the intrusion detection device 200 is further described below with reference to FIGS. 3 to 5.

According to an embodiment, the intrusion detection device 200 may receive an external command from the outside (e.g., an external module 350 or the server 250) and process the received command. The intrusion detection device 200 may receive an external command from a backend server on an external network. An external command that the intrusion detection device 200 may receive from the server 250 may include a settings modification command, a log data request command, a real-time status check command, a report generation command, a notification transmission command, and a settings initialization command. The settings modification command may be a command to modify or update an operation manner and/or a detection rule of the intrusion detection device 200. For example, the settings modification command may include a ruleset reload command. The log data request command may be a command for the server 250 to request log data (e.g., a detection log) for a particular time period from the intrusion detection device 200. The real-time status check command may be a command to search real-time data on activities or security threats being detected by the intrusion detection device 200. The report generation command may be a command to generate a report on security-related events (e.g., security threats, intrusions, or attacks) for a particular time period. The notification transmission command may be a command to transmit a warning notification for security-related events and/or intrusion attempts. The settings initialization command may be a command to return settings of the intrusion detection device 200 to an initial state. The intrusion detection device 200 may perform intrusion detection differently based on an external command. For example, the intrusion detection device 200 may perform intrusion detection differently based on a detection rule included in an external command. The intrusion detection device 200 may generate and store an intrusion detection result as a log. For example, detection results may be generated and stored as detection logs and hash (e.g., detection logs and hash 395). The intrusion detection device 200 may output the detection results as detection logs or perform a system and organization controls (SOC) report, based on the detection results. The SOC report may be a report that evaluates whether a system is appropriately designed and operated. The intrusion detection device 200 may transmit the detection results of detecting an intrusion in the vehicle 210 to the server 250 in the form of an SOC report.

FIG. 3 is a diagram illustrating an intrusion detection device in a vehicle network, according to an embodiment.

Referring to FIG. 3, according to an embodiment, an intrusion detection device 300 (e.g., the intrusion detection device 200 of FIG. 2 or the electronic device 700 of FIG. 7) may include a plurality of modules (e.g., a receiver module 301, a first module 310, a second module 320, a third module 330, an external command receiver module 360, an external command decoding module 370, and a command processing module 380). The intrusion detection device 300 may detect intrusion within a vehicle network using the plurality of modules. The plurality of modules may be independent code blocks that perform a given task and may be executed in a processor (e.g., the processor 730 of FIG. 7) of the intrusion detection device 300. Each module may process data or interact with other modules. The plurality of modules may include the receiver module 301, the first module 310 that performs decoding, the second module 320 that detects intrusion, the third module 330 that processes a detection result, the external command receiver module 360, the external command decoding module 370, and the command processing module 380. The plurality of modules may be connected in a plug-in form. The plug-in form structure may be a structure in which each functional block is modularized and connected such that a new function may be easily added, deleted, or changed in a software system. The plurality of modules may be connected in a plug-in form such that a new module may be inserted between particular modules, or an existing module may be easily deleted. For example, when it is desired to additionally perform preprocessing on a message, a system administrator (e.g., an administrator of the intrusion detection device 300) may easily add a preprocessing process by inserting a preprocessing module (not shown) between the receiver module 301 and the first module 310. For example, when it is desired to additionally perform filtering on a decoded message, the system administrator may easily add a filtering process by inserting a filtering module immediately after the first module 310 that performs decoding. Each of the plurality of modules (e.g., the receiver module 301, the first module 310, the second module 320, the third module 330, the external command receiver module 360, the external command decoding module 370, and the command processing module 380) may include a message queue. The message queue may be a data structure that temporarily stores data in a computer system, and may be a structure that allows a receiver (e.g., a subject to process data) to process data when desired in response to a sender (e.g., a subject transmitting data) inputting the data in a queue. A message queue may store data in a first in, first out (FIFO) manner, and may transmit messages to a subject to process the data in sequence. According to an embodiment, a communication circuit 340 may include a communication circuit for a CAN BUS system. The CAN BUS may be a standard communication protocol used for communication between components (e.g., ECUs) inside a vehicle (e.g., the vehicle 210 of FIG. 2). A protocol may define a standardized format and transmission scheme of data to support fast and reliable communication between components inside the vehicle 210. The communication circuit 340 may be physically connected to the intrusion detection device 300 to transmit messages to the intrusion detection device 300. The messages may include messages transmitted within a vehicle network. The vehicle network may include a CAN for communication between components inside the vehicle 210. The vehicle network may include ethernet.

According to an embodiment, the receiver module 301 may acquire a message from the communication circuit 340. The receiver module 301 may include a message queue 305. The receiver module 301 may receive a message transmitted within a vehicle network (e.g., a vehicle network such as CAN or ethernet) and transmit the message to the first module 310. The receiver module 301 may verify a format of the received message. For example, the receiver module 301 may verify whether the received message is a message in a format conforming to a CAN protocol. After the format of the message is verified, the receiver module 301 may transmit the message to the first module 310. After the message is transmitted to the first module 310, the receiver module 301 may receive a new message. For example, after the message is transmitted to another module, the receiver module 301 may sequentially receive a new message. The first module 310 may sequentially acquire messages transmitted within the vehicle network. The first module 310 may perform decoding on the received message. The first module 310 may include a message queue 315 and a decoding engine 317. The decoding engine 317 may include one or more decoding engines (e.g., decoding engines 317_1 to 317_n). The decoding engine 317 may be a plurality of decoding engines (e.g., the decoding engines 317_1 to 317_n) connected to each other. The decoding engines 317_1 to 317_n may be connected in a plug-in form. For example, the connection between the decoding engines 317_1 to 317_n may be connected in the form of a plug-in such that it is easy to add a new decoding engine and change and/or delete an existing decoding engine. The first module 310 may read a message to be processed from the message queue 315. The first module 310 may parse a message, distinguish required field values, and perform decoding. The first module 310 may sequentially decode the message and transmit the message to the second module 320 that detects intrusion among the plurality of modules. After the message is transmitted to the second module 320, the first module 310 may receive a new message from the receiver module 301. After the message is transmitted to the second module 320, the first module 310 may sequentially receive the new message from the receiver module 301 and perform decoding. The intrusion detection device 300 may perform tasks efficiently by waiting until each module has finished its task, not starting tasks on a new message, and performing tasks in parallel again when the tasks corresponding to each module is finished. For example, the intrusion detection device 300 may perform a task (e.g., decoding) again using the first module 310 in response to the first module 310 transmitting a decoded message to the second module 320, and thus may perform tasks efficiently.

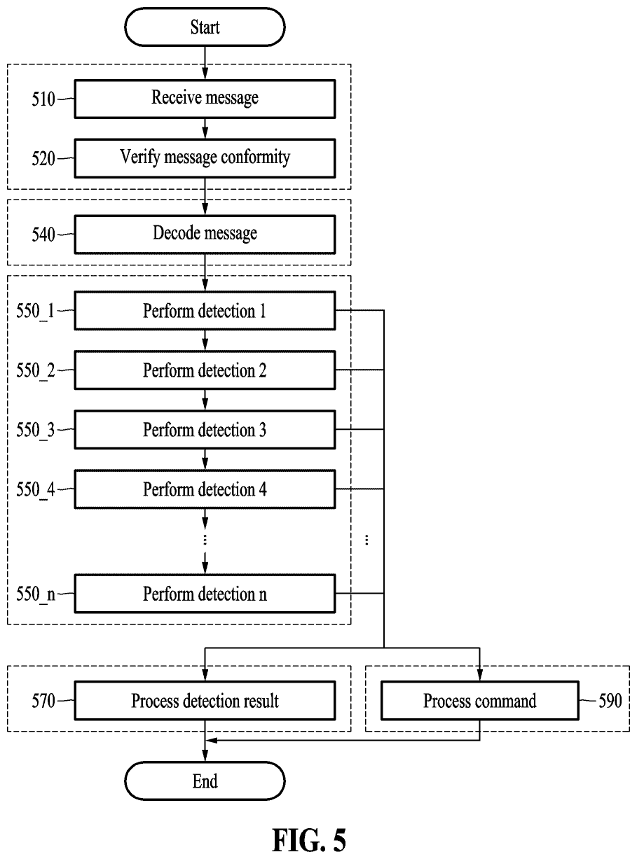

According to an embodiment, the second module 320 may include a message queue 325 and a detection engine 327. The detection engine 327 may include one or more detection engines (e.g., detection engines 327_1 to 327_n). The detection engine 327 may be a plurality of detection engines (e.g., the detection engines 327_1 to 327_n) connected to each other. The detection engines 327_1 to 327_n may be connected in a plug-in form. For example, the connection between the detection engines 327_1 to 327_n may be connected in a plug-in form such that it is easy to add a new detection engine and change and/or delete an existing detection engine. The intrusion detection device 300 may easily add, delete, or replace various detection engine codes based on a strategy pattern received from the external module 350. The second module 320 may sequentially detect intrusion for a message output from the first module 310. Each of the plurality of detection engines may sequentially detect intrusion for a message output from the first module 310, based on a corresponding detection technique. The detection technique may be determined based on a system ruleset 393. For example, the intrusion detection device 300 may receive the system ruleset 393, which is a policy to be used by each detection engine for operation, from the external module 350, and determine a detection technique to be used by each detection engine. The detection technique may include detection techniques that may detect different threats. For example, the detection technique may include detection techniques such as a whitelist-based intrusion detection technique, a blacklist-based intrusion detection technique, a signature-based intrusion detection technique, and an anomaly detection-based intrusion detection technique. A whitelist-based intrusion detection technique may be a detection technique that allows only pre-approved activities or traffic and blocks all other activities. A blacklist-based intrusion detection technique may be a detection technique that blocks pre-defined malicious activities or traffic. A signature-based intrusion detection technique may be a detection technique that detects known attack patterns or signatures. An anomaly detection-based intrusion detection technique may be a detection technique that detects abnormal activities that deviate from a baseline of normal activities. The intrusion detection techniques described above are merely examples, and the intrusion detection techniques that the plurality of detection engines (e.g., the detection engines 327_1 to 327_n) of the intrusion detection device 300 may perform to detect intrusion in messages are not limited to the described examples. The detection techniques may vary depending on the detection engine. For example, the detection techniques to be used by each detection engine may be determined based on a threat level of an intrusion and/or attack that may be detected. The priority of the detection techniques may vary depending on the threat level of an intrusion and/or attack that may be detected. For example, detection techniques in order of high threat level of a detectable intrusion and/or attack may sequentially correspond to a high-priority detection engine (e.g., a detection engine with a fast detection order). The plurality of detection engines (e.g., the detection engines 327_1 to 327_n) may sequentially detect intrusion for a message output from the first module 310. For example, the plurality of detection engines (e.g., the detection engines 327_1 to 327_n) may perform intrusion detection serially. The plurality of detection engines (e.g., the detection engines 327_1 to 327_n) may sequentially detect intrusions for decoded messages received by the second module 320 from the first module 310. For example, after the detection engine 327_1 detects whether an intrusion exists in a message stored in the message queue 325, the detection engine 327_1 may transmit the message to the detection engine 2 327_2. The message stored in the message queue 325 may include a decoded message received from the first module 310. When at least one detection engine among the plurality of detection engines (e.g., the detection engines 327_1 to 327_n) detects an intrusion in the decoded message, the detection engine that detects the intrusion may transmit a detection result to the third module 330 that processes the detection result among the plurality of modules. For example, when the detection engine 327_1 detects an intrusion in the decoded message, the detection engine 327_1 may transmit a detection result to the third module 330. The detection result may include information on a detected intrusion. The detection result may also be transmitted to the command processing module 380. The process of transmitting the detection result to the third module 330 and the command processing module 380 and processing the detection result is further described below with reference to FIG. 5. The detection engine that detects an intrusion may transmit the message output from the first module 310 to a next detection engine. Each detection engine (e.g., the detection engine 327_1) may detect whether an intrusion exists in a message and then transmit the message to the next detection engine (e.g., the detection engine 2 327_2). For example, the detection engine 327_1 may detect whether an intrusion exists in a message and, when an intrusion is detected, transmit a detection result to the third module 330 and the command processing module 380 and transmit the message to the detection engine 2 327_2, which is the next detection engine. For example, the detection engine 327_1 may detect whether an intrusion exists in a message and, when an intrusion is not detected, transmit the message to the detection engine 2 327_2, which is the next detection engine. That is, the detection engine may transmit the message to the next detection engine regardless of whether an intrusion is detected, so that all detection engines may perform intrusion detection on the message. After the last detection engine (e.g., the detection engine n 327_n) completes intrusion detection on the message, the second module 320 may receive a new message. For example, when the detection engine n 327_n completes intrusion detection on the message and transmits the message to the third module 330 and/or the command processing module 380, the second module 320 may receive a decoded message from the first module 310.

According to an embodiment, the third module 330 may receive a detection result from the second module 320. The third module 330 may receive a detection result from one or more detection engines (e.g., one or more detection engines among the detection engines 327_1 to 327_n) of the second module 320. The third module 330 may include a message queue 335 and a result processing engine 337. The third module 330 may store a message received from the second module 320 in the message queue 335. The third module 330 may process the detection result. The result processing engine 337 may process the message and/or the detection result received from the second module 320. The third module 330 may output a detection log (e.g., the detection logs and hash 395) based on the detection result. The detection log may include a record of intrusions and/or attacks. The third module 330 may perform an SOC report based on the detection result. The SOC report may be used to evaluate and report on the reliability of a system, and may include a report used to prove that a system meets reliability principles such as security, confidentiality, and personal information protection.

According to an embodiment, the external module 350 may include a server (e.g., the server 250) and/or device outside the intrusion detection device 300. The intrusion detection device 300 may receive an external command from the external module 350. The external command receiver module 360 may receive an external command from the external module 350. The external command may include a command such as ruleset reload, a system (e.g., an intrusion detection system (IDS)) information request, or the like. The external command receiver module 360 may include a message queue 365. The external command receiver module 360 may transmit the received external command to the external command decoding module 370. After transmitting the external command to the external command decoding module 370, the external command receiver module 360 may receive a new external command. For example, the external command receiver module 360 may perform operations in parallel with other modules (e.g., the external command decoding module 370 or the command processing module 380) using the message queue 365. The external command decoding module 370 may receive an external command from the external command receiver module 360 and decode the received external command. The external command decoding module 370 may include a message queue 375. The external command decoding module 370 may decode the external command and transmit the decoded external command to the command processing module 380. After transmitting the decoded external command to the command processing module 380, the external command decoding module 370 may receive a new external command. For example, the external command decoding module 370 may perform operations in parallel with other modules (e.g., the external command receiver module 360 or the command processing module 380) using the message queue 375. The command processing module 380 may receive a detection result from the second module 320. The command processing module 380 may include a message queue 385 and a command processing engine 387. The command processing module 380 may receive a decoded external command from the external command decoding module 370. The command processing module 380 may perform a task based on the external command. For example, the command processing engine 387 may receive a command to update the system ruleset 393 from the external module 350 and update the system ruleset 393. For example, the command processing module 380 may receive a command to stop or reboot the intrusion detection device 300 and stop an operation of the intrusion detection device 300 or reboot the intrusion detection device 300. The command processing module 380 may perform an SOC report based on a detection result. The command processing module 380 may transmit the SOC report to the external module 350 to perform the SOC report to an external server.

According to an embodiment, the intrusion detection device 300 may include a storage 390 (e.g., a memory 710 of FIG. 7). The intrusion detection device 300 may store a system settings file 391, the system ruleset 393, and the detection logs and hash 395 in the storage 390. The system settings file 391 and the system ruleset 393 may be received from the external module 350. The detection logs and hash 395 may be generated by the third module 330 based on a detection result.

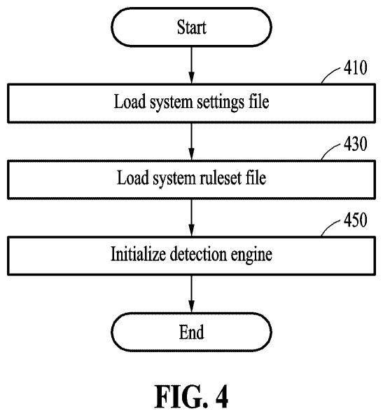

FIG. 4 is a flowchart illustrating a system initialization process according to an embodiment.

Referring to FIG. 4, according to an embodiment, operations 410 to 450 may be initialization operations performed by the intrusion detection device 300 (e.g., the intrusion detection device 200 of FIG. 2 or the electronic device 700 of FIG. 7) described with reference to FIG. 3. Operations 410 to 450 may be performed by a processor (e.g., the processor 730 of FIG. 7) of the intrusion detection device 300.

In operation 410, the intrusion detection device 300 may load a system settings file (e.g., the system settings file 391 of FIG. 3).

In operation 430, the intrusion detection device 300 may load a system ruleset file (e.g., the system ruleset file 393). The system ruleset file 393 may include detection rules. The intrusion detection device 300 may receive a system ruleset file from the outside (e.g., the external module 350) and store the received system ruleset file in the storage 390.

In operation 450, the intrusion detection device 300 may initialize a detection engine. The detection engine may be substantially the same as the detection engines 327_1 to 327_n described with reference to FIG. 3. The intrusion detection device 300 may initialize the detection engines 327_1 to 327_n based on the loaded system settings file and/or system ruleset file. After completing the initialization operation, the intrusion detection device 300 may sequentially acquire messages transmitted within a vehicle network.

In an embodiment, operations 410 to 450 may be performed sequentially, but are not limited thereto. For example, two or more operations may be performed in parallel.

FIG. 5 is a flowchart illustrating an intrusion detection process according to an embodiment.

Referring to FIG. 5, according to an embodiment, operations 510 to 590 may be performed by a processor (e.g., the processor 730 of FIG. 7) of the intrusion detection device 300 (e.g., the intrusion detection device 200 of FIG. 2 or the electronic device 700 of FIG. 7) described with reference to FIG. 3.

In operation 510, the intrusion detection device 300 may receive a message. The intrusion detection device 300 may receive a message from a communication circuit (e.g., the communication circuit 340 of FIG. 3). The intrusion detection device 300 may acquire the message from the communication circuit 340 using a receiver module (e.g., the receiver module 301).

In operation 520, the intrusion detection device 300 may verify a conformity of the message. The intrusion detection device 300 may verify the conformity of the acquired message using the receiver module 301. For example, the receiver module 301 may verify the conformity of the message by checking and verifying whether the message is in a format that conforms to a CAN protocol. Operations 510 and 520 are substantially the same as the operation of the receiver module 301 described with reference to FIG. 3, and thus, any overlapping description thereof is omitted.

In operation 540, the intrusion detection device 300 may decode the message. The intrusion detection device 300 may receive the message and information about the message, and decode the message. The intrusion detection device 300 may decode the message using the first module 310. For example, the first module 310 may parse the message based on the message and the information about the message, distinguish necessary field values, and perform decoding. Operation 540 is substantially the same as the operation of the first module 310 described with reference to FIG. 3, and thus, any overlapping description thereof is omitted.

In operations 550_1 to 550_n, the intrusion detection device 300 may perform intrusion detection on the decoded message. An intrusion detection module (e.g., the second module 320) of the intrusion detection device 300 may receive a decoded message output from the first module 310. The intrusion detection device 300 may perform intrusion detection on the decoded message using the second module 320. A plurality of detection engines (e.g., the detection engines 327_1 to 327_n) included in the second module 320 may sequentially detect intrusions on the received message. Regardless of whether an intrusion is detected, a detection engine may transmit the message to a next detection engine so that all detection engines may perform intrusion detection on the message. Operations 550_1 to 550_n are substantially the same as the operations of the second module 320 described with reference to FIG. 3, and thus, any overlapping description thereof is omitted.

In operation 570, the intrusion detection device 300 may process a detection result. The intrusion detection device 300 may process the detection result using a module (e.g., the third module 330) that processes results. The third module 330 may receive the detection result from the second module 320. The third module 330 may output a detection log based on the detection result. Operation 570 is substantially the same as the operation of the third module 330 described with reference to FIG. 3, and thus, any overlapping description thereof is omitted.

In operation 590, the intrusion detection device 300 may process a command. The intrusion detection device 300 may process an external command using a module (e.g., the command processing module 380) that processes external commands. The intrusion detection device 300 may receive an external command from an external module (e.g., the external module 350) using an external command receiver module (e.g., the external command receiver module 360). The external command receiver module 360 may receive an external command and transmit the received external command to an external command decoding module (e.g., the external command decoding module 370). The external command decoding module 370 may decode the external command and transmit the decoded external command to the command processing module 380. The command processing module 380 may receive the decoded external command and perform processing. Operation 590 is substantially the same as the operation of the command processing module 380 described with reference to FIG. 3, and thus, any overlapping description thereof is omitted.

According to an embodiment, operations 510 to 590 may be performed sequentially, but are not limited thereto. For example, two or more operations may be performed in parallel.

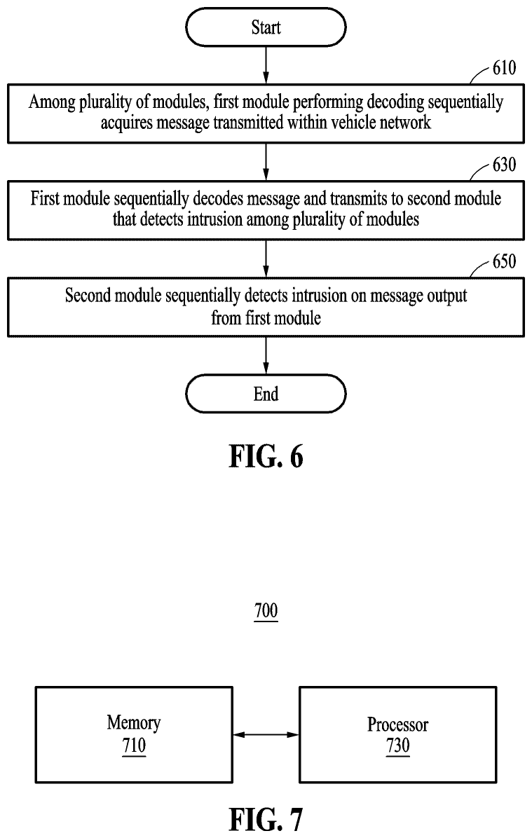

FIG. 6 is a flowchart illustrating a method of detecting intrusion in a vehicle network according to an embodiment.

Referring to FIG. 6, according to an embodiment, operations 610 to 650 may be substantially identical to the method performed by the intrusion detection device 200 of FIG. 2 described with reference to FIGS. 1 to 5.

In operation 610, a first module that performs decoding among a plurality of modules may sequentially acquire a message transmitted within a vehicle network.

In operation 630, the first module may sequentially decode the message and transmit the decoded message to a second module that detects intrusion among the plurality of modules. The plurality of modules may each include a message queue, and may perform operations in parallel based on the message queue. For example, the first module and the second module may perform operations in parallel.

In operation 650, the second module may sequentially detect intrusion on a message output from the first module.

Operations 610 to 650 may be performed sequentially, but are not limited thereto. For example, two or more operations may be performed in parallel.

FIG. 7 is a schematic block diagram of an electronic device according to an embodiment.

Referring to FIG. 7, according to an embodiment, the electronic device 700 (e.g., the intrusion detection device 100 of FIG. 1) may include the memory 710 and the processor 730.

The memory 710 may store instructions (or programs) executable by the processor 730. For example, the instructions may include instructions for executing operations of the processor 730 and/or operations of each component of the processor 730.

The memory 710 may include one or more computer-readable storage media. The memory 710 may include non-volatile storage elements (e.g., magnetic hard disc, optical disc, floppy disc, flash memory, electrically programmable read-only memory (EPROM), and electrically erasable and programmable read-only memory (EEPROM)).

The memory 710 may be non-transitory media. The term “non-transitory” may indicate that a storage medium is not implemented as a carrier wave or propagated signal. However, the term “non-transitory” should not be interpreted to mean that the memory 710 is unable to move.

The processor 730 may process data stored in the memory 710. The processor 730 may execute computer-readable code (e.g., software) stored in the memory 710 and instructions triggered by the processor 730.

The processor 730 may be a hardware-implemented data processing device having circuitry with a physical structure for executing desired operations. For example, the desired operations may include code or instructions included in a program.

For example, the hardware-implemented data processing device may include a microprocessor, a central processing unit (CPU), a processor core, a multi-core processor, a multiprocessor, an application-specific integrated circuit (ASIC), or a field programmable gate array (FPGA).

The processor 710 may cause the electronic device 700 to perform one or more operations by executing code and/or instructions stored in the memory 730. The operations performed by the electronic device 700 may be substantially the same as the operations performed by the intrusion detection device 100 described with reference to FIGS. 1 to 7. Therefore, any overlapping description related thereto is omitted.

The embodiments described herein may be implemented using hardware components, software components, or a combination thereof. A processing device may be implemented using one or more general-purpose or special purpose computers, such as, for example, a processor, a controller and an arithmetic logic unit (ALU), a digital signal processor, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of detecting intrusion in a vehicle network using a plurality of modules, the method comprising:
sequentially acquiring, by a first module that performs decoding among the plurality of modules, a message transmitted within the vehicle network;
transmitting, by the first module, the message to a second module that detects intrusion among the plurality of modules, by sequentially decoding the message; and
sequentially detecting intrusion with respect to a message output from the first module by the second module,
wherein the plurality of modules each comprises a message queue, and performs operations in parallel based on the message queue.

2. The method of claim 1, wherein the second module comprises
a plurality of detection engines,
wherein each of the plurality of detection engines is configured to
sequentially detect intrusion with respect to the message output from the first module, based on a corresponding detection scheme.

3. The method of claim 2, further comprising:
when at least one detection engine of the plurality of detection engines detects intrusion with respect to the decoded message, transmitting a detection result to a third module that processes detection results among the plurality of modules by detection engine that detects the intrusion.

4. The method of claim 3, further comprising:
transmitting the message output from the first module to a next detection engine by the detection engine that detects the intrusion.

5. The method of claim 1, wherein the plurality of modules are connected in a plug-in form.

6. The method of claim 1, wherein the vehicle network comprises
a controller area network (CAN) for communication between components in a vehicle.

7. A non-transitory computer-readable storage medium storing instructions that, when executed by a processor, cause the processor to perform the method of claim 1.

8. An apparatus for detecting intrusion in a vehicle network using a plurality of modules, the apparatus comprising:
at least one processor; and
memory including instructions that, when executed individually or collectively by the at least one processor, cause the apparatus to:
sequentially acquire, by a first module that performs decoding among the plurality of modules, a message transmitted within the vehicle network;
transmit, by the first module, the message to a second module that detects intrusion among the plurality of modules, by sequentially decoding the message; and
sequentially detect intrusion with respect to a message output from the first module by the second module,
wherein the plurality of modules each comprises a message queue, and performs operations in parallel based on the message queue.

9. The apparatus of claim 8, wherein the second module comprises
a plurality of detection engines,
wherein each of the plurality of detection engines is configured to
sequentially detect intrusion with respect to the message output from the first module, based on a corresponding detection scheme.

10. The apparatus of claim 9, wherein the instructions, when executed individually or collectively by the at least one processor, cause the apparatus to:
when at least one detection engine of the plurality of detection engines detects intrusion with respect to the decoded message, transmit a detection result to a third module that processes detection results among the plurality of modules by detection engine that detects the intrusion.

11. The apparatus of claim 10, wherein the instructions, when executed individually or collectively by the at least one processor, cause the apparatus to:
transmit the message output from the first module to a next detection engine by the detection engine that detects the intrusion.

12. The apparatus of claim 8, wherein the plurality of modules are connected in a plug-in form.

13. The apparatus of claim 8, wherein the vehicle network comprises
a controller area network (CAN) for communication between components in a vehicle.
